(19) United States
(12) Patent Application Publication
(10) Pub. No.: US 2010/0226578 A1
(43) Pub. Date: Sep. 9, 2010

(54) OBJECT DETECTING APPARATUS, AND OBJECT DETECTING METHOD

(76) Inventor: Yoshiyuki KOKOJIMA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/562,634

(22) Filed: Sep. 18, 2009

(30) Foreign Application Priority Data
Mar. 3, 2009 (JP) 2009-49579

(51) Int. Cl. G06K 9/46

(52) U.S. Cl. 382/195

(57) ABSTRACT

An object detecting apparatus includes a plurality of feature value calculating units that are provided for respective different features of an image and perform a process of extracting the features from an attention region in parallel; a plurality of combining units detecting combinations of the features in parallel, the plurality of combining units are provided for the respective combinations of the features included in the attention region, the plurality of combining units detect the combinations from a outputted features from the plurality of feature value calculating units; and a plurality of identifying units that are provided corresponding to the plurality of combining units and perform in parallel a process of identifying an object based on the combinations detected by the combining units.

### CROSS-REFERENCE TO RELATED APPLICATIONS

This application is based upon and claims the benefit of priority from the prior Japanese Patent Application No. 2009-049579, filed on Mar. 3, 2009; the entire contents of which are incorporated herein by reference.

### BACKGROUND OF THE INVENTION

1. Field of the Invention

The present invention relates to an apparatus and method for detecting an object, such as a human face, from an image.

2. Description of the Related Art

A method for detecting an object, such as a human face, from an image is disclosed in Viola et al., “Rapid Object Detection using a Boosted Cascade of Simple Features”, IEEE Conference on Computer Vision and Pattern Recognition, 2001 (hereinafter, “Viola”). In the method, in order to detect whether an object is included in an attention region of the image, a plurality of (a set of) pixel regions are arranged in the attention region. Then, the difference value of the brightness between the pixel regions (Haar-like feature value) is calculated. The calculated feature value is compared with a threshold value that has been created in advance by learning in order to detect whether an object is included in the attention region. Although the accuracy of the object detection with only one threshold value is not sufficient, it is possible to improve the accuracy of the object detection by changing the arrangement of the pixel regions and repeatedly performing the threshold value process plural times.

Also, a method and an apparatus that apply the threshold value process to a plurality of brightness difference values (joint Haar-like features) in order to evaluate the correlation (co-occurrence) between a plurality of features, thereby detecting an object with high accuracy is disclosed in JP-A 2006-268825. Basically, a human face is symmetric with respect to the vertical direction, and features, such as the eyes or the eyebrows, are arranged at two positions. Instead of applying a single threshold value process, the object detecting apparatus takes into account the specific feature of the human face, that is, features are included at two left and right points at the same time.

In recent years, graphics processing units (GPUs) have been used in many video apparatuses. Originally, GPUs are dedicated hardware components for displaying a three-dimensional CG (computer graphics) at a high speed in, for example, games. In recent years, GPUs have progressed to general-purpose parallel processors capable of performing processes other than CG processing at a high speed. A parallel processing method for allowing a GPU to perform the object detecting method disclosed in Viola at a high speed is disclosed in Ghorayeb et al., “Boosted Algorithms for Visual Object Detection on Graphics Processing Units”, Asian Conference on Computer Vision, 2006.

The object detecting method disclosed in JP-A 2006-268825, which uses the joint Haar-like features, includes applying the threshold value process to a plurality of different kinds of brightness difference values. Thus, it is difficult to increase the processing speed by parallelizing a process that calculates one feature.

### SUMMARY OF THE INVENTION

According to one aspect of the present invention, an object detecting apparatus includes a plurality of feature value calculating units that are provided for respective different features of an image and perform a process of extracting the features from an attention region in parallel; a plurality of combining units detecting combinations of the features in parallel, the plurality of combining units are provided for the respective combinations of the features included in the attention region, the plurality of combining units detect the combinations from a outputted features from the plurality of feature value calculating units; and a plurality of identifying units that are provided corresponding to the plurality of combining units and perform in parallel a process of identifying an object based on the combinations detected by the combining units.

According to another aspect of the present invention, an object detecting apparatus includes an setting unit that sets a plurality of attention regions in an input image; and a plurality of identifying units that are provided for the respective attention regions and each detects whether an object is included in the attention region, wherein each of the identifying units comprises a plurality of feature value calculating units that are provided for respective different features of the image and perform a process of extracting the features from the attention region in parallel; a plurality of combining units detecting a combinations of the features in parallel, the plurality of combining units are provided for the respective combinations, the plurality of combining units detect the combinations from a outputted features from the plurality of feature value calculating units; and a plurality of identifiers that are provided corresponding to the plurality of combining units and perform in parallel a process of identifying the object based on the combinations detected by the combining units.

According to still another aspect of the present invention, an object detecting method includes extracting different features of an image from an attention region in parallel; detecting combinations of the features included in the attention region in parallel, the features are extracted; and identifying objects for the respective combinations in parallel.

### BRIEF DESCRIPTION OF THE DRAWINGS

FIG. 1 is a block diagram illustrating a schematic configuration of an object detecting apparatus according to an embodiment of the invention;

FIG. 2 is a diagram illustrating a detailed configuration of an identifying unit;

FIG. 3 is a diagram illustrating examples of sets of pixel regions;

FIG. 4 is a diagram illustrating examples of pixel regions, in which shapes of the pixel regions are limited to rectangles;

FIG. 5 is a diagram illustrating examples of arranging a plurality of features on a face image;

FIG. 6 is a diagram illustrating a structure of data used when calculating the same kind of features in each group;

FIG. 7 is a flowchart illustrating a procedure of an entire object detecting process;

FIG. 8 is a flowchart illustrating a detailed process performed by the identifying unit; and

FIG. 9 is a diagram illustrating an example hardware configuration for implementing the object detecting apparatus according to the embodiment, in which solid lines indicate a flow of data and a dotted line indicates control.

### DETAILED DESCRIPTION OF THE INVENTION

Hereinafter, exemplary embodiments of the invention will be described with reference to the accompanying drawings. In the following embodiment, a method of using the joint Haar-like features is described as an example of extracting a plurality of features of an image to detect an object. However, the invention is not limited to the method using the joint Haar-like features. A method may be used which extracts the same kind of features from a plurality of features of an image and uses different kinds of combinations of the features to detect an object.

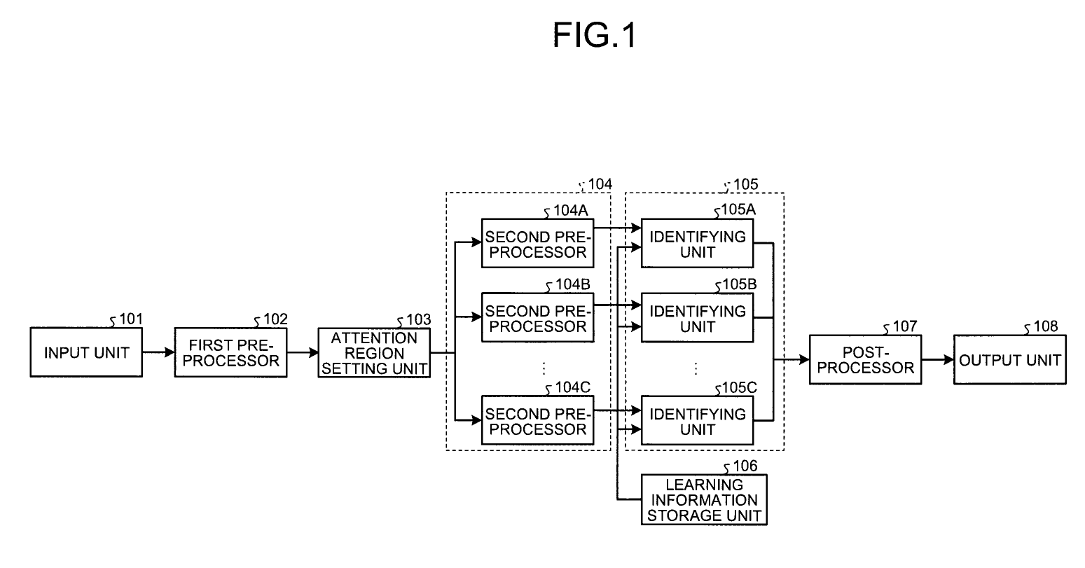

In FIG. 1, arrows indicate the flow of data between blocks of an object detecting apparatus. The object detecting apparatus according to the embodiment includes an input unit 101, a first pre-processor 102, an attention region setting unit 103, a second pre-processor 104, an identifying unit 105, a learning information storage unit 106, a post-processor 107, and an output unit 108.

An image to be subjected to an object detecting process is input to the input unit 101. The image may be stored in a memory device, such as a hard disk drive (HDD), a DRAM, or an EEPROM. The image may also be input by an imaging apparatus, such as a camera. In addition, image data that is encoded (compressed) in a certain format may be decoded by a decoder, and the decoded data may be input.

The first pre-processor 102 performs pre-processing, such as smoothing and brightness correction, on the entire image in order to remove noise or the influence of variation in illumination that are included in the image. It is preferable to use the logarithm of the brightness of a pixel. In an object detecting process, by the use of the difference value of the logarithm of the brightness, not the difference value of the brightness, an object can be accurately detected even when the image has a dynamic range different from that of a sample image that has been previously used for learning.

The first pre-processor 102 may perform pre-processing, such as histogram equalization, or pre-processing for making the mean and variance of the brightness constant. The first pre-processor 102 may output an input image to the next stage, without performing any processing.

The attention region setting unit 103 sets an attention region to be subjected to the object detecting process. The attention region is a rectangular region having a predetermined size, and is also called a “scanning window”. A plurality of attention regions are set at positions that are shifted by a predetermined step width from the origin of an image in the horizontal and vertical directions.

When an object in the image and the attention region have substantially the same size, the object detecting apparatus according to the embodiment determines that the object is included in the attention region. When an object in the image and the attention region are set at different positions or have different sizes, the object detecting apparatus determines that the object is not included in the attention region.

The attention region setting unit 103 sets attention regions of various sizes, thereby making it possible to detect objects having various sizes in the image.

In an object detecting apparatus that does not perform a parallel process on a plurality of attention regions, object detections are sequentially performed on the attention regions, while moving the attention regions (scanning windows) by a predetermined step width. Also, object detections are repeatedly performed on the attention regions while changing the sizes of the attention regions.

The object detecting apparatus according to the embodiment does not sequentially perform object detections on various attention regions that are disposed at different positions and have different sizes, but performs a parallel process on the attention regions using a parallel processor, such as a GPU. The number of the second pre-processors 104 and the identifying units 105, described later, is set to be equal to the number of attention regions to be processed.

The second pre-processor 104 performs pre-processing on a partial image in each of the attention regions set by the attention region setting unit 103. The second pre-processor 104 includes second pre-processors 104A to 104C. The number of second pre-processors is equal to the number of the attention regions to be processed. While the first pre-processor 102 performs the pre-processing on the entire image, the second pre-processor 104 performs the pre-processing on each partial image in the attention region. The second pre-processor 104 may output the partial image to the next stage without performing any processing.

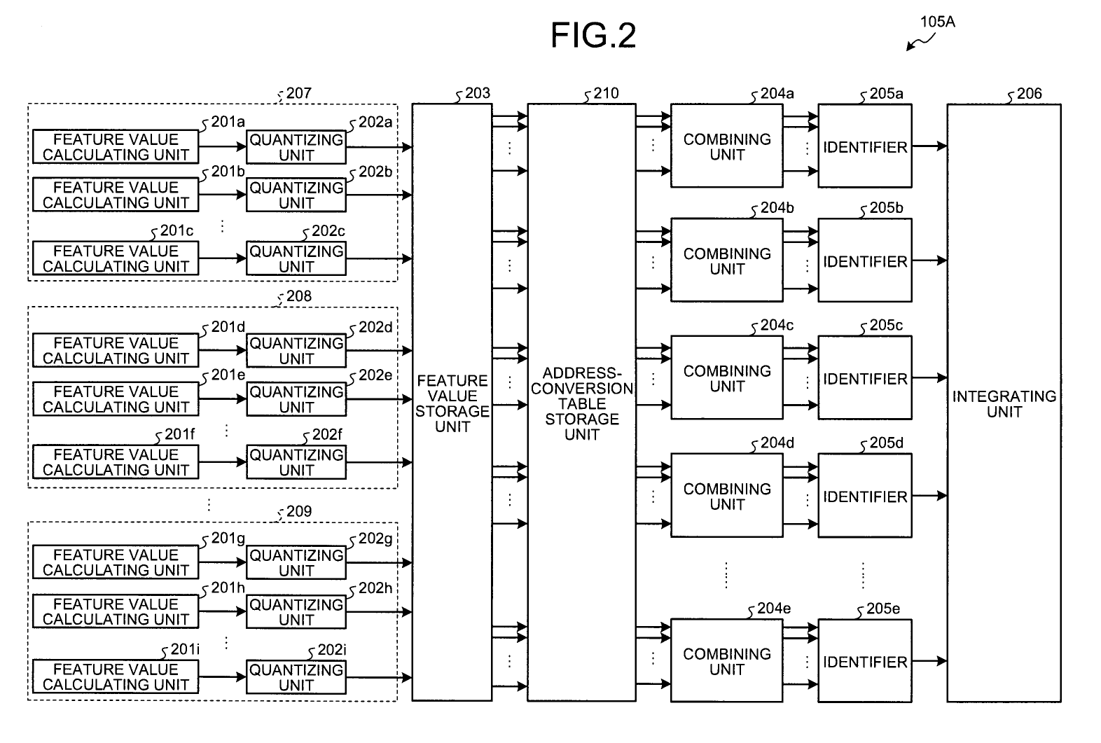

The identifying unit 105 determines whether an object is included in the partial image in each attention region. If it is determined that the object is included in the partial image, the identifying unit 105 sets the position of the attention region as a detection position. The identifying unit 105 will be described later in detail with reference to FIG. 2.

The learning information storage unit 106 is a memory device that stores various data referred to by the identifying unit 105 to detect the object. The learning information storage unit 106 is, for example, an HDD, a DRAM, or a flash memory. The data stored in the learning information storage unit 106 is information that indicates features of an image. Examples of such information are information on the position or shape of a pixel region when a brightness difference value is calculated, information on a combination thereof, and a threshold value. The data is created in advance by learning using sample images.

The post-processor 107 combines a plurality of detection positions obtained by performing the identifying process on a plurality of attention regions in order to obtain one detection position for one object. The identifying unit 105 performs identifications on the attention regions that are disposed at different positions and have different sizes, which are set by the attention region setting unit 103, and a plurality of detection positions may be obtained for one object depending on the sizes and step widths of the attention regions. The post-processor 107 integrates the identification results.

The output unit 108 outputs information on object detection results. The output unit 108 stores the information in a memory device, such as an HDD, a DRAM, or an EEPROM. The output unit 108 may output the information to, for example, another apparatus, a system, or a program (not shown).

In FIG. 2, an identifying unit 105A, which is one of the identifying units provided in the identifying unit 105, is illustrated as an example. The other identifying units have the same configuration. The identifying unit 105A includes feature value calculating units 201a to 201i, quantizing units 202a to 202i, a feature value storage unit 203, an address-conversion table storage unit 210, combining units 204a to 204e, identifiers 205a to 205e, and an integrating unit 206.

The feature value calculating units 201a to 201i and the quantizing units 202a to 202i are divided into a plurality of groups. A group 207 includes the feature value calculating units 201a to 201c and the quantizing units 202a to 202c. A group 208 includes the feature value calculating units 201d to 201f and the quantizing units 202d to 202f. A group 209 includes the feature value calculating units 201g to 201i and the quantizing units 202g to 202i.

First, the feature value calculating unit 201a, which is one feature value calculating unit 201, will be described. The feature value calculating unit 201a arranges a plurality of (a set of) pixel regions in the partial image output from the second pre-processor 104A, and calculates the weighted sum of the pixels in the set of the pixel regions.

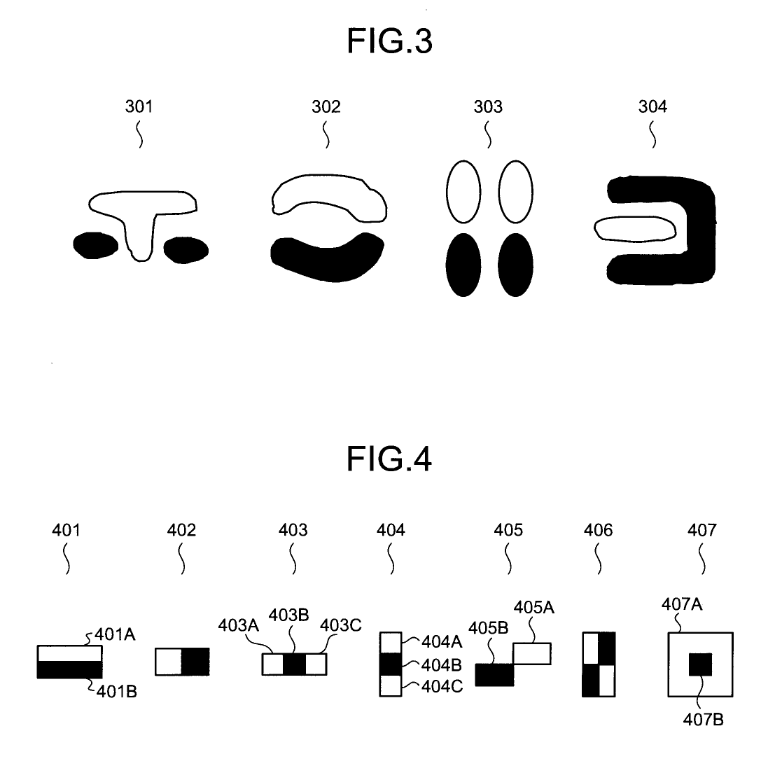

As illustrated in FIG. 3, a set 301 includes three pixel regions, and a set 302 includes two pixel regions. The position and shape of each pixel region and the total number of pixel regions are created in advance by learning using the sample images, and are stored in the learning information storage unit 106.

The feature value calculating unit 201a calculates a feature value corresponding to one of the sets 301 to 304 shown in FIG. 3, for example. The feature value calculated by the feature value calculating unit 201a for the set of the pixel regions is the weighted sum D of the pixel values.

The following Expression 1 is for calculating the weighted sum D of the pixel values.

$$D = {\sum }_{i = 1}^{n} {w}_{i} \cdot {I}_{i} \qquad ( 1 )$$

In Expression 1, n indicates the number of pixel regions, Wᵢ indicates the weight of each pixel region, and Iᵢ indicates the sum of the pixel values in each pixel region. When the pixel regions are divided into two regions of white and black regions as illustrated in FIG. 3, the weighted sum D can be calculated by Expression 2 given below:

D=w_{W}·I_{W}+w_{B}·I_{B} (2)

In Expression 2, W_{W} and W_{B} indicate the weights of the white and black pixel regions, respectively, and I_{W} and I_{B} indicate the sums of the pixel values in the white and black pixel regions, respectively. When the area (the number of pixels) of the white pixel region and the area (the number of pixels) of the black pixel region are indicated as A_{W} and A_{B}, respectively, the weights W_{W} and W_{B} are defined by Expression 3 given below:

$${w}_{W} = \frac{1}{{A}_{W}} , {w}_{B} = - \frac{1}{{A}_{B}} \qquad ( 3 )$$

The weighted sum D in Expression 2 is the difference value between the average brightnesses of the pixel regions. The weighted sum D takes various values depending on the arrangement, size, and shape of the pixel region. The weighted sum D is a feature value that indicates the feature of the image. In this embodiment, the weighted sum D is referred to as a “feature value”, and a set of the pixel regions is referred to as a “feature value” or a “feature value region”.

In this embodiment, an example of using the difference value between the average brightnesses defined by Expressions 2 and 3 as the feature value is described. Alternatively, instead of the difference value between the average brightnesses, the difference value between the absolute values of the average brightnesses or between the logarithms of the average brightnesses may be used as the feature value. Although the pixel region can be set to include only one pixel, it is preferable to obtain the average brightness from plural pixels because the pixel region is more likely to be affected by noise as the size of the pixel region is reduced.

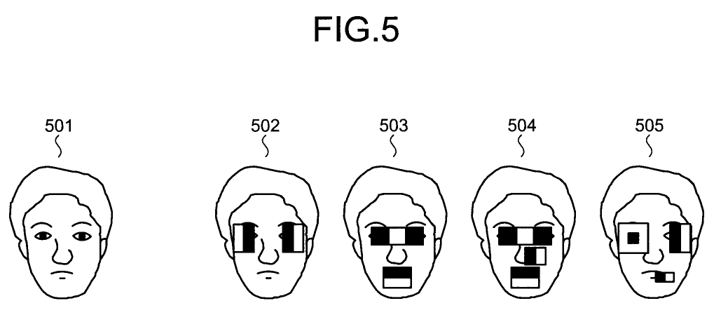

As illustrated in FIG. 4, a feature 401 includes two rectangular regions 401A and 401B that are adjacent to each other in the vertical direction. A feature 402 includes two rectangular regions that are adjacent to each other in the horizontal direction.

Each of the feature 401 and the feature 402 is the most basic set of the rectangular regions, and the feature value obtained from the feature indicates a gradient of brightness, that is, the direction and intensity of the edge. As the area of the rectangle is increased, an edge feature having a lower spatial frequency can be extracted. In addition, when the difference value between the absolute values of the brightnesses is used as the feature value, the direction of the gradient of brightness cannot be represented, but whether an edge is included can be obtained. This is a feature value that is effective for the outline of an object that has indefinite background brightness.

A feature 403 includes three rectangular regions 403A to 403C arranged in the horizontal direction, and a feature 404 includes three rectangular regions 404A to 404C arranged in the vertical direction.

A feature 405 includes two rectangular regions 405A and 405B arranged in the oblique direction. Since the rectangular regions 405A and 405B are arranged in the oblique direction, the feature 405 may be used to calculate a gradient of brightness in the oblique direction. A feature 406 includes four rectangular regions arranged in a matrix of two rows and two columns. A feature 407 includes a rectangular region 407A and a rectangular region 407B that is arranged at the center of the rectangular region 407A. The feature 407 is a feature value that is effective in detecting an isolated point.

As in the features 401 to 407, when the shape of the pixel region is limited to a rectangle, it is possible to reduce the value of calculation for calculating the sum of the pixel values using an integral image.

When the sets of the pixel regions are arranged adjacent to each other, it is possible to evaluate a tendency to an increase and decrease in the brightness of a partial region. For example, when an object is to be detected from an image that is captured outside in daylight, in many cases, there is a large brightness variation in the surface of the object due to the influence of illumination. In such a case, it is possible to reduce the influence of the absolute brightness variation, considering the tendency to the increase and decrease in the brightness of a partial region.

The object detecting process according to the embodiment uses sets of adjacent rectangular regions as features. Therefore, the value of calculation can be reduced, and robustness against variation in illumination conditions can be obtained.

FIG. 5 is a diagram illustrating an example in which a plurality of feature values are arranged on a face image when an object to be detected is a human face. Reference numeral 501 denotes a face image to be detected, which is captured from the front side. The face image captured from the front side is substantially symmetric with respect to the vertical direction.

Reference numeral 502 denotes an image in which two features are arranged in the vicinity of two eyes. The directions and intensities of the gradients of brightness obtained from the rectangular regions in the image 502 are correlated with each other. The method using the joint Haar-like features uses the correlation between the features to improve the detection accuracy of an object. Sometimes, it is difficult to identify an object using a single feature. It becomes possible to accurately identify the object by appropriately combining the features for each detection target.

Similarly, images 503 to 505 are examples of using the correlation between the features obtained from the rectangular regions to improve the detection accuracy of an object.

The image 503 is an example in which the feature of three rectangular regions is arranged so as to be laid across two eyes and the feature of two rectangular regions is arranged in the vicinity of the lip. The arrangement of the two kinds of features makes it possible to evaluate whether the image includes two kinds of specific features of the human face in which a portion between the eyebrows of the face is brighter than the eye and the lip is darker than a portion in the vicinity the lip.

The image 504 and the image 505 are examples that include three features. As such, it is possible to represent a combination of specific features of a detection target by appropriately selecting the number or kind of features.

In an object detecting apparatus that does not perform a parallel process, one identifying unit includes a plurality of feature value calculating units and one feature is allocated to each feature value calculating unit, for example. In the case of an image that includes two features arranged therein, such as the images 502 and 503, processes are allocated to two feature value calculating units included in one identifying unit. Similarly, in the case of an image that includes three features arranged therein, such as the images 504 and 505, processes are allocated to three feature value calculating units included in one identifying unit.

In an object detecting apparatus that does not perform a parallel process, more accurate identification results can be obtained by providing a plurality of identifying units and integrating identification results of combinations of different features. For example, one identifying unit calculates the feature value of the image 502 and another identifying unit calculates the feature value of the image 503 in parallel, and then the calculated two identification results are combined to finally determine whether the object is a face.

However, the above-mentioned configuration of identifying units is not suitable for implementation using a parallel processor, such as a GPU. The parallel processing method of the GPU, which is called single program multiple data (SPMD), can be applied to process a very large value of data in parallel, but the programs for performing the process need to be the same. That is, the GPU executes only one program at a time and cannot execute a plurality of programs in parallel. In order to operate a plurality of identifying units each allocated with a combination of different features in parallel, the identifying units need to execute different programs to calculate the feature values. Of course, it is possible to change processing procedures to some extent using conditional branching in the program. However, as is well known, when conditional branching is included in the program to be executed, the process performance of a parallel processor, such as a GPU, is significantly lowered.

The object detecting apparatus according to the embodiment does not treat a combination of a plurality of features set for each detection target, but decomposes the combination, classifies the features into groups each including the same kind of features, and allows the GPU to perform the parallel process on each group. The features included in the same group, that is, the same kind of features have the same number of rectangular regions or have rectangular regions arranged in the same direction. Therefore, it is possible to perform the parallel process by one program without any conditional branching. As a result, the object detecting apparatus according to the embodiment can use the GPU to effectively calculate the feature value.

The object detecting process according to the embodiment will be described below using the face image shown in FIG. 5 as an example. The same kind of features is arranged in the vicinities of the right and left eyes in the image 502, in the vicinity of the nose in the image 504, and in the vicinities of the left eye and the nose in the image 505. Each of these features includes two sets of rectangular regions arranged in the horizontal direction and corresponds to the feature 402 shown in FIG. 4. There is a difference in the positions and sizes of the rectangular regions arranged and the order of the white and black regions, but the features have the same number of rectangular regions and the rectangular regions are arranged in the same direction. Therefore, it is possible to perform the parallel process by one program without any conditional branching. By classifying these features in the same group, the GPU can effectively perform processing. In addition, the number of rectangular regions or the arrangement thereof is referred to as “the kind of feature”.

The feature 403, in which three rectangular regions are arranged in the horizontal direction so as to be laid across two eyes, is arranged in the vicinities of two eyes in the images 503 and 504. In this case, the process for calculating the feature 403 of the image 503 and the process for calculating the feature 403 of the image 504 can be classified in the same group and can be processed in parallel by one GPU.

The feature 401, in which two rectangular regions are arranged in the vertical direction, is arranged in the vicinity of the mouth in the images 503 and 504. In this case, the process for calculating the feature 401 of the image 503 and the process for calculating the feature 401 of the image 504 can be classified in the same group can be processed in parallel by one GPU.

In the object detecting apparatus according to the embodiment, the internal structure of the identifying unit 105 is constructed such that a parallel processor, such as a GPU, is used to effectively perform the process. As shown in FIG. 2, in the identifying unit 105, a plurality of feature value calculating units 201 and a plurality of quantizing units 202 are classified into a plurality of groups 207, 208, and 209. The feature value calculating units 201 and the quantizing units 202 belonging to the same group process the same kind of features in parallel. For example, the feature value calculating units 201 and the quantizing units 202 belonging to the group 207 process the feature 401 in parallel. The feature value calculating units 201 and the quantizing units 202 belonging to the group 208 process the feature 402 in parallel. The feature value calculating units 201 and the quantizing units 202 belonging to the group 209 process the feature 403 in parallel.

The process of grouping the same kind of features is performed in advance, and the grouping results are stored in the learning information storage unit 106. The data includes various data that is referred to by the identifying unit 105 to detect an object.

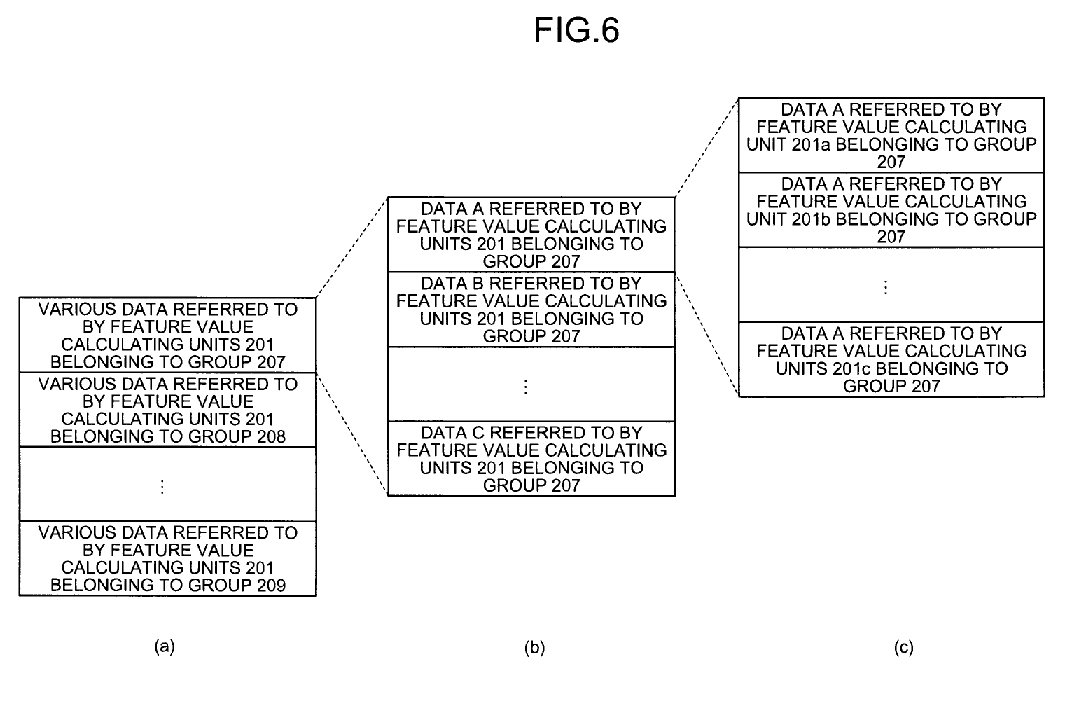

In FIG. 6, (a) illustrates an example of the arrangement of data stored in the learning information storage unit 106, (b) illustrates in detail a portion of the data shown in (a), and (c) illustrates in detail a portion of the data shown in (b).

As shown in (a), various data referred to by the feature value calculating units 201 belonging to the same group is sequentially stored in the memory. As shown in (b), various data referred to by the feature value calculating units 201 belonging to one group is stored in the memory such that pieces of data of the same kind are grouped and those groups are sequentially stored in the memory. As shown in (b), data A, data B, and data C are various data related to the feature values, such as the arrangement positions of the features, the sizes of the rectangular regions, and the order of the white and black regions arranged.

As shown in (c), the same kind of data is sequentially stored in the memory in the order in which the data is referred to by the feature value calculating units 201a, 201b, and 201c.

When the feature value calculating units 201a, 201b, and 201c belonging to the group 207 are operated in parallel to calculate the feature values, first, the data A is read in parallel by the feature value calculating units 201a, 201b, and 201c. At that time, a continuous series of addresses in the learning information storage unit 106 is accessed. Then, the data B is read in parallel by the feature value calculating units 201a, 201b, and 201c. Thereafter, the data C is read in parallel by the same method. In any of the reading operations, a continuous series of addresses in the learning information storage unit 106 is accessed. When all data is completely read, the feature value calculating units 201a, 201b, and 201c perform feature value calculating processes in parallel. When the feature value calculating processes are completed, the feature value belonging to the next group 208 is calculated by the same method as described above.

A parallel processor, such as a GPU, accesses a continuous series of memory addresses in parallel. Therefore, it is possible to read data more effectively, that is, at a high speed. As shown in FIG. 6, the learning information storage unit 106 is configured such that addresses of each of various data are arranged in series so as to be continuously read or written when the feature value is calculated. Thus, a parallel processor, such as a GPU, can effectively read data.

Referring to FIG. 2 again, each identifying unit 105 reads information about grouping from the learning information storage unit 106, and allocates the features to be processed to the feature value calculating unit 201 on the basis of the information. The decomposed features are combined again by a combining unit 204, which will be described later.

Each of the quantizing units 202a to 202i quantizes the feature value calculated by the feature value calculating unit 201 connected thereto. That is, the quantizing unit quantizes the weighted sum of the pixel values in a plurality of stages. Information about the number of stages corresponding to which the quantizing unit 202 quantizes the feature value and a threshold value for quantization are created in advance by learning using the sample images and are stored in the learning information storage unit 106. For example, when the feature value is quantized in two stages, the quantizing unit 202 outputs a value 0 or 1. The quantized feature value is referred to as a “quantized feature value”.

The feature value storage unit 203 is a memory device that stores the quantized feature values output from a plurality of quantizing units 202. The feature value storage unit 203 is, for example, an HDD, a DRAM, or an EEPROM.

The address-conversion table storage unit 210 is a memory device that stores table data that indicates the memory addresses of the quantized feature values, which are to be combined by each combining unit 204, in the feature value storage unit 203. The address-conversion table storage unit 210 is, for example, an HDD, a DRAM, or an EEPROM.

The combining unit 204 generates a combination of feature values in accordance with the joint Haar-like features. First, the combining unit 204 obtains the memory addresses of the feature value storage unit 203 that store a plurality of quantized feature values to be combined, with reference to an address conversion table which is stored in the address-conversion table storage unit 210. Then, the combining unit 204 reads a plurality of quantized feature values stored in the obtained memory addresses and outputs the quantized feature values to an identifier 205 in the next stage.

Each identifier 205 identifiers whether an object is included in a partial image in the attention region on the basis of the values of a plurality of quantized feature values output from each combining unit 204. Specifically, first, the identifier calculates the probability that all input quantized feature values are observed at the same time, with reference to a probability table. The probability that all input quantized feature values are observed at the same time is referred to as “joint probability”. The probability table may be stored in a storage unit (not illustrated) that is provided in each identifier 205. Alternatively, the probability table referred to by a plurality of the identifiers 205 may be stored in one or more storage units (not illustrated).

The probability table includes two kinds of tables, which are a table related to an object to be detected and a table related to a non-object. The non-object means that “it is not an object”. The probability table is created in advance by learning using the sample images and is stored in the learning information storage unit 106. The identifier 205 calculates two probability values with reference to the two tables. The two probability values are also called “likelihoods”.

Then, the identifier 205 compares two likelihoods obtained by the following Expression 4 to identify whether an object is included.

$$\begin{matrix}{h}_{t} ( x ) = \{ \frac{P ( {v}_{1} , … {v}_{F} \vert object )}{P ( {v}_{1} , … , {v}_{F} \vert non \text{-} object )} \} > λ & ⇒ object \\ otherwise & ⇒ non \text{-} object\end{matrix} \qquad ( 4 )$$

In Expression 4, hₜ(x) indicates a discriminant function for obtaining the identification result of an image x. P(v₁, . . . , v_{f}, . . . , v_{F}|Object) and P(v₁, . . . , v_{f}, . . . , v_{F}|non-Object) indicate the likelihood of an object and the likelihood of a non-object referred to by the probability table, respectively. V_{f} indicates the value of the quantized feature value. λ indicates a threshold value for identifying an object, and is created by learning using the sample images and stored in the learning information storage unit 106.

The identifier 205 outputs two kinds of discrete values, which are (a label “+1” indicating that the partial image in the attention region is an object) and (a label “−1” indicating that the partial image in the attention region is a non-object). The identifier 205 may output a likelihood ratio or the ratio of the logarithm of the likelihood, that is, a log-likelihood ratio. The log-likelihood ratio is a positive value when the partial image in the attention region is an object, and is a negative value when the partial image in the attention region is a non-object.

The size of the probability table referred to by the identifier 205 is determined by the number of features and the number of stages for quantizing the feature values. For example, when the identifier 205 that uses three features quantizes the feature value obtained from each feature in two stages, the total number of combinations of the quantized feature values is 2×2×2=8. When the feature value obtained from an f-th feature in a total of F sets of features is quantized in L_{f} stages, the total number L_{A} of combinations of the quantized feature values is calculated by Expression 5 given below:

$${L}_{A} = {\prod }_{f = 1}^{F} {L}_{f} \qquad ( 5 )$$

In this embodiment, the probability values are stored in two kinds of probability tables, and two probability values read from the two probability tables are compared with each other. Alternatively, the comparison result may be stored in one of the two kinds of tables, and the table may be referred to. In this case, the label “+1” or “−1”, the likelihood ratio, or the log-likelihood ratio may be stored in the table. With this, calculation costs can be reduced.

The integrating unit 206 integrates a plurality of identification results output from each identifier 205 and calculates a final identification result. When the number of identifiers 205 is T, a weighted voting process is performed on T identification results hₜ(x) to calculate a final identification result H(x) by Expression 6 given below:

$$H ( x ) = {\sum }_{t = 1}^{T} {α}_{t} \cdot {h}_{t} ( x ) \qquad ( 6 )$$

In Expression 6, αₜ indicates the weight of each identifier 205. The weight of each identifier is created in advance by learning using the sample images and is stored in the learning information storage unit 106. The integrating unit 206 compares the obtained identification result H(x) with a predetermined threshold value to finally determine whether the partial image is an object. In general, a threshold value of 0 is used, and the integrating unit 206 performs the determination depending on whether the value of H(x) is positive or negative.

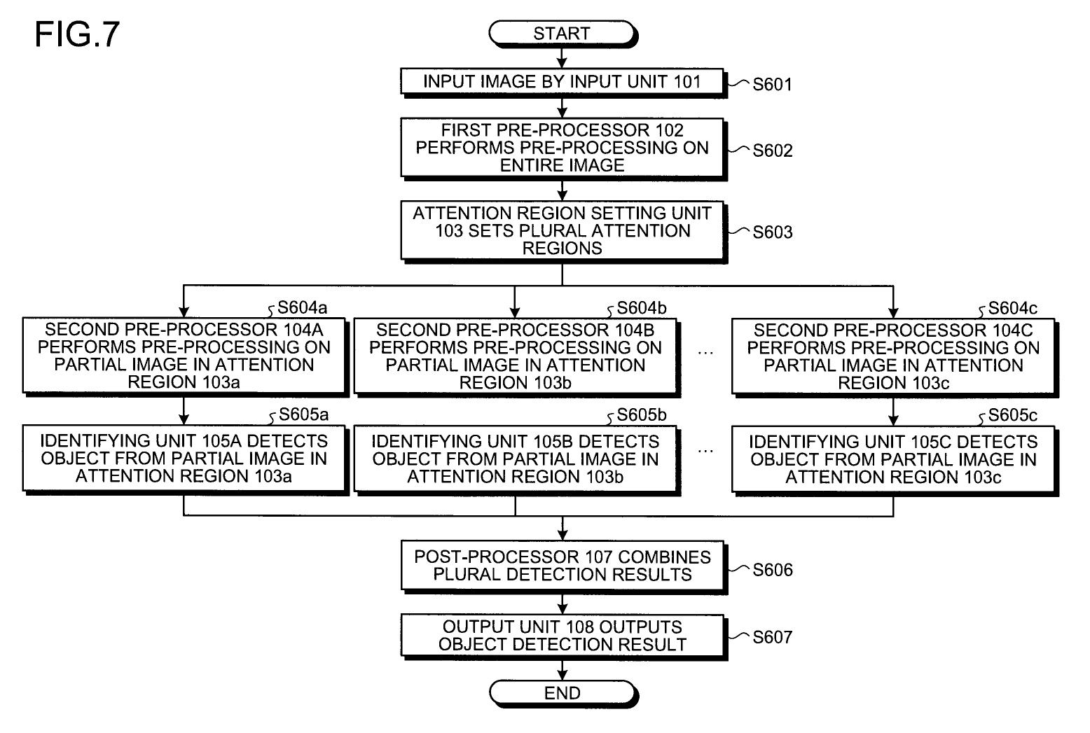

In Step S601 of FIG. 7, an image is input by the input unit 101. In Step S602 subsequent to Step S601, the first pre-processor 102 performs pre-processing on the image input in Step S601. The process is performed on the entire image.

In Step S603 subsequent to Step S602, the attention region setting unit 103 sets a plurality of attention regions 103a to 103c. The number of set attention regions may be equal to the number of identifying units. Then, the process proceeds to Steps S604a to S604c subsequent to Step S603.

In Step S604a, the second pre-processor 104A performs pre-processing on a partial image in the attention region 103a. In Step S605a subsequent to Step S604a, the identifying unit 105A detects an object from the partial image in the attention region 103a.

The process in Steps S604b and S605b, and the process in Steps S604c and S605c are similar to each other except that they are performed by different second pre-processors 104 and different identifying units 105, and thus a detailed description thereof will be omitted.

In Step S606 subsequent to Steps S605a to S605c, the post-processor 107 combines a plurality of results obtained in Step S604 and Step S605. In Step S607 subsequent to Step S606, the output unit 108 outputs the detection result of the object in Step S606.

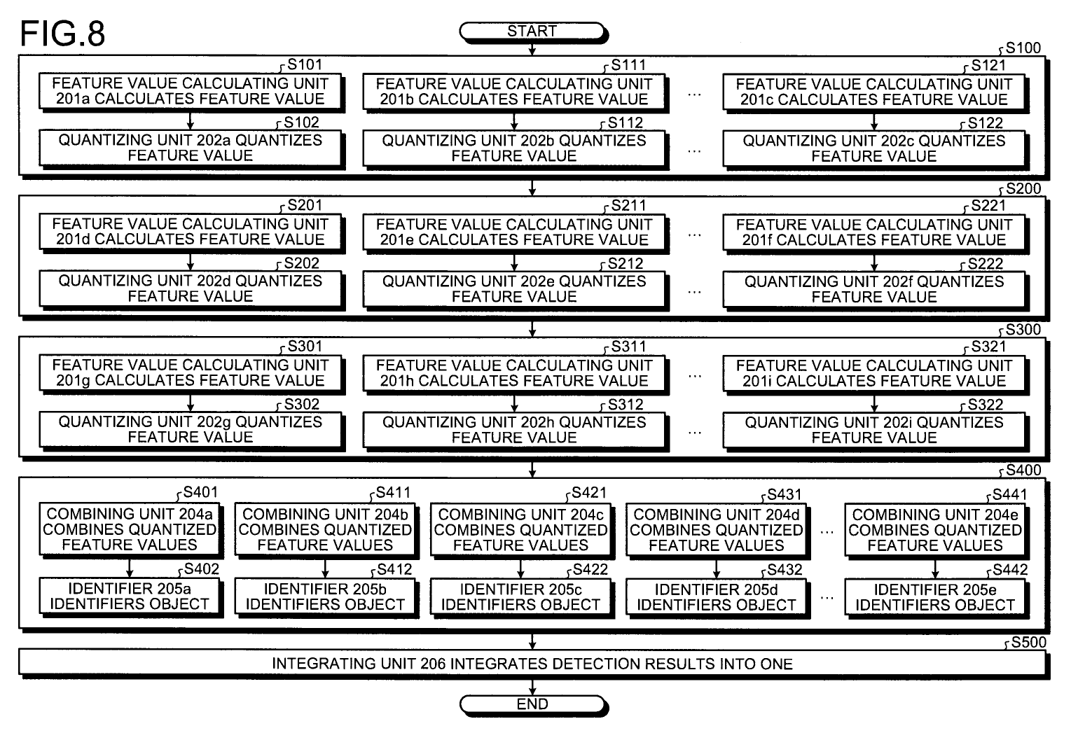

In Step S100 of FIG. 8, a process of calculating the features of the group 207 is performed. Step S100 includes Step S101, Step S102, Step S111, Step S112, Step S121, and Step S122.

In Step S101, the feature value calculating unit 201a calculates the feature value of the set partial image. In Step S102 subsequent to Step S101, the quantizing unit 202a quantizes the feature value detected in Step S101 to calculate a quantized feature value. The calculated quantized feature value is stored in the feature value storage unit 203.

The other steps included in Step S100 are performed by a combination of the feature value calculating units and the quantizing units belonging to the group 207. The process in the steps is the same as that in Step S101 and Step S102 and thus a description thereof will be omitted. The features calculated in Step S100 are of the same kind.

In Step S200 subsequent to Step S100, a process of calculating the features of the group 208 is performed. A process of Step S200 is similar to Step S100 except that the kind of feature calculated in Step S200 is different from that calculated in Step S100, and thus a description thereof will be omitted.

In Step S300 subsequent to Step S200, a process of calculating the features of the group 209 is performed. Step S300 is similar to Step S100 or Step S200 except that the kind of feature calculated in Step S300 is different from that calculated in Step S100 and Step S200, and thus a description thereof will be omitted.

In Step S400 subsequent to Step S300, the combining units 204a to 204e combine the quantized feature values included in each of the joint Haar-like features, and the identifiers 205a to 205e identify an object on the basis of the combination of the quantized feature values.

Step S400 includes Step S401, Step S402, Step S411, Step S412, Step S421, Step S422, Step S431, Step S432, Step S441, and Step S442.

In Step S401, the combining unit 204a reads and acquires one or more quantized feature values forming one joint Haar-like feature from the feature value storage unit 203 using the address conversion table, and outputs the detected quantized feature values to the identifier 205a.

In Step S402 subsequent to Step S401, the identifier 205a identifies an object on the basis of the quantized feature values read in Step S401. The processes of the other steps included in Step S400 are similar to those in Step S401 and Step S402 except that they are performed by different combining units and different identifiers, and thus a description thereof will be omitted.

In Step S500 subsequent to Step S400, the integrating unit 206 integrates the detection results of the steps included in Step S400.

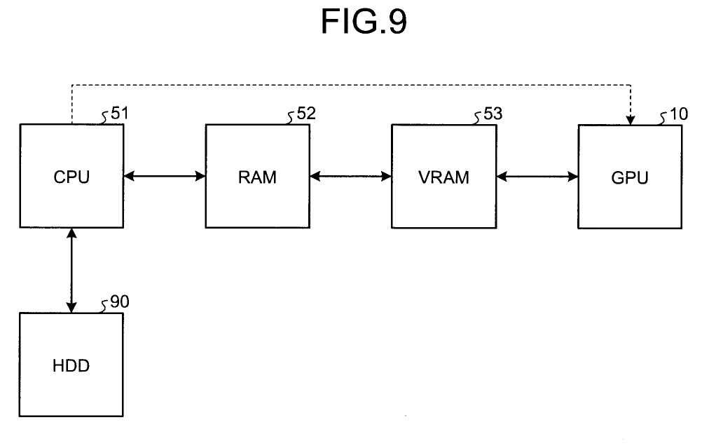

The configuration shown in FIG. 9 includes a CPU 51, a RAM 52, a VRAM 53, a GPU 10, and an HDD 90.

The CPU 51 reads the program stored in the RAM 52 and executes the read program. With this, the CPU 51 implements the functions of the first pre-processor 102 and the attention region setting unit 103. The RAM 52 is a memory that stores the program and functions as a work memory when the CPU 51 executes the program.

The VRAM 53 is a memory that stores images to be subjected to the object detecting method according to this embodiment. The GPU 10 performs a plurality of pre-processes and a plurality of identifying processes of the object detecting method according to this embodiment in parallel. The HDD 90 stores, for example, the images or the programs.

According to the object detecting apparatus of this embodiment, the GPU can effectively perform a method of detecting an object, such as a human face, from the image using the joint Harr-like features.

The invention is not limited to the above-described embodiment, but various modifications and changes of the invention can be made without departing from the scope and spirit of the invention. In addition, a plurality of components according to the above-described embodiment may be appropriately combined with each other to form various structures. For example, some of all the components according to the above-described embodiment may be removed. In addition, the components according to different embodiments may be appropriately combined with each other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An object detecting apparatus comprising:
a plurality of feature value calculating units that are provided for respective different features of an image and perform a process of extracting the features from an attention region in parallel;
a plurality of combining units detecting combinations of the features in parallel, the plurality of combining units are provided for the respective combinations of the features included in the attention region, the plurality of combining units detect the combinations from a outputted features from the plurality of feature value calculating units; and
a plurality of identifying units that are provided corresponding to the plurality of combining units and perform in parallel a process of identifying an object based on the combinations detected by the combining units.

2. The apparatus according to claim 1, wherein each of the feature value calculating units, which extracts the feature of same kind, mutually exclusively performs the process of extracting the feature.

3. The apparatus according to claim 1, further comprising a feature value storage unit that stores information of the outputted features from the plurality of feature value calculating units,
wherein the combining unit detect the combinations from the feature value storage unit.

4. An object detecting apparatus comprising:
an setting unit that sets a plurality of attention regions in an input image; and
a plurality of identifying units that are provided for the respective attention regions and each detects whether an object is included in the attention region,
wherein each of the identifying units comprises
a plurality of feature value calculating units that are provided for respective different features of the image and perform a process of extracting the features from the attention region in parallel;
a plurality of combining units detecting a combinations of the features in parallel, the plurality of combining units are provided for the respective combinations, the plurality of combining units detect the combinations from a outputted features from the plurality of feature value calculating units; and
a plurality of identifiers that are provided corresponding to the plurality of combining units and perform in parallel a process of identifying the object based on the combinations detected by the combining units.

5. The apparatus according to claim 4, further comprising a storage unit that stores information related to the features of the image, which is used when the identifying unit detects the object, in an order corresponding to a process order of the plurality of feature value calculating units included in the identifying unit.

6. An object detecting method comprising:
extracting different features of an image from an attention region in parallel;
detecting combinations of the features included in the attention region in parallel, the features are extracted; and
identifying objects for the respective combinations in parallel.

7. The method according to claim 6, wherein the extracting process is performed mutually exclusively on respective kinds of the features in parallel.

8. The method according to claim 6, further comprising setting a plurality of the attention regions in the input image,
detecting objects performed for respective attention regions.
